(19) United States
(12) Patent Application Publication
(10) Pub. No.: US 2003/0191632 A1
(43) Pub. Date: Oct. 9, 2003

(54) Utilization of agent idle time in a communication system

(75) Inventors: Roger A. Sumner, Batavia, IL (US); Mark J. Power, Carol Stream, IL (US); Carlo Bonifazi, Woodridge, IL (US); Jeffrey D. Hodson, Wheaton, IL (US); Craig R. Shambaugh, Wheaton, IL (US); Mark J. Michelson, Elburn, IL (US); Robert P. Beckstrom, Bolingbrook, IL (US); Anthony J. Dezonno, Bloomingdale, IL (US)

Correspondence Address: John R. Garrett, Welsh & Katz, Ltd., 22nd Floor, 120 South Riverside Plaza, Chicago, IL, 60606, US

(73) Assignee: Rockwell Electronic Commerce Technologies, L.L.C., Wood Dale, IL

(21) Appl. No.: 10/118,882

(22) Filed: Apr. 9, 2002

(51) Int. Cl. G10L 21/00

(52) U.S. Cl. 704/201

(57) ABSTRACT

The method and apparatus utilizes agents idle time in a communication system, such as, a communication system having an automatic call distribution system. The method includes providing at least one plug-in that implements at least one predetermined function in the call distribution system. At least one plug-in is assigned to at least one agent. At least one plug-in is activated for a respective assigned agent in response to at least one predetermined parameter of the automatic call distribution system. The predetermined parameter may be the entering into an available/idle time by the respective agent. The plug-in may be one of training, agent-to-agent collaboration, mentoring, and monitoring. The apparatus implements the method. The knowledge and skills associated with agents that are not actively handling call related activities are essentially untapped knowledge areas that other agents currently handling call related activities have access to by utilizing this method and apparatus.

### BACKGROUND

The field of the invention relates to communication systems and, in particular, to communication systems having automatic call distributors.

Automatic call distribution systems are known. Such systems are typically used, for example, as a means of distributing telephone calls among a group of agents. Automatic call distributors may be, but not limited to hardware and/or software systems with many possible configurations including distributed systems, integrated systems, systems based on one or more personal computers or servers, and the like.

Often an organization disseminates a single telephone number to its customers and to the public in general as a means of contacting the organization. The term “calls” refers not only to conventional telephone calls, but to any customer contacts including but not limited to facsimile, e-mail, Internet communications such as web chat and VOIP (Voice Over Internet Protocol). As calls are directed to the organization from the public switch telephone network or other communication system, the automatic call distribution system directs the calls to its agents based upon some type of criteria. For example, where all agents are considered equal, the automatic call distributor may distribute the calls based upon which agent has been idle the longest. The agents that are operatively connected to the automatic call distributor may be live agents, and/or virtual agents. Typically, virtual agents are, for example, software routines and algorithms that are operatively connected and/or part of the automatic call distributor.

Automatic call distributors are often utilized in communications handling centers, such as telephone call centers, that forward incoming communications for processing by one of several associated call-handling agents. Such communications centers may be used to forward voice-over-internet protocol communications; electronic mail messages; facsimiles or the like, to associated handling agents.

Call centers, for example, are often used to dispatch emergency services, as telemarketing sales centers, as customer service centers, etc. to automatically distribute received calls. Each incoming call may have a number of handling requirements, depending on, for example, the nature of the call, the originating call area, and the language of the call. Agents, on the other hand, each have abilities to process calls having certain handling requirements. Typically, agents are able to process one or more call types. For example, agents may be trained to process certain call subject matters and certain call languages.

In known call centers, computerized automatic call distributors place incoming telephone calls, of a particular type, requiring defined skills, in queues of like calls. Appropriate agents have skills necessary to process calls in the queues, and are assigned to such queues. Agents are often assigned to multiple queues, reflective of their particular handling skills. Typically, this is done to increase the handling capacity of the center by making improved use of available communications handling resources.

Quite often, agents may handle calls related to one or more subject areas, and possess varied attributes that are relevant to all subject areas they are capable of handling. For example, a telephone call center agent may speak multiple languages, and may therefore be able to process telephone calls relating to a particular subject matter in all these languages. One simple approach used to deal with multiple agent attributes is to create and administer individual queues, each of which takes into account the subject matter and the attributes of the agent. This, however, is administratively very cumbersome.

Other known call centers use agent-skill indicators, associated with agents in order to connect calls. In such centers, a call is connected to an agent having an agent-skill indicator matching that of the call, within a group of agents. Agents, however, are typically only assignable to only one, and typically only a single agent-skill indicator is used to connect the call. Disadvantageously, such call centers do not use agent attributes across different groups. This may lead to an inefficient utilization of call center resources. Moreover, these communications handling centers do not allow for easy administration and re-assignment of agents to queues, while maintaining agent skill-sets.

One concern in designing an automatic call distributor system is ensuring that calls are efficiently routed to an agent, so as to minimize the amount of time that any particular call waits to be handled. One basic technique of minimizing on-hold time is to employ a first-in/first-out call handling technique. The first-in/first-out technique requires that calls be routed to the next available agent in the order in which the calls are received. However, in some automatic call distributor systems the agents are specialized in handling particular types of calls, so the first-in/first-out technique is not appropriate. For example in a product support department of a software facility, agents might be grouped according to specialized expertise, so that a first group is knowledgeable in word processing, a second group is knowledgeable in a database program, and a third group is knowledgeable in a spreadsheet program. Utilizing a first-in/first-out technique in such a situation is inappropriate, because a caller with a question regarding the word processing program may be routed to an agent having specialized knowledge regarding the database program or the spreadsheet program, rather than being routed to an agent with specialized knowledge in the word processing program.

The focus in the management of calls has been upon maximizing availability to customers, so as to achieve an acceptable profit margin in a competitive environment of customer service. Call management approaches that increase revenue may lead to savings for customers.

Most present-day call-distribution algorithms focus on being “fair” to callers and to agents. This fairness is reflected by the standard first-in, first-out call to most-idle-agent assignment algorithm. Skills-based routing improves upon this basic algorithm in that it allows each agent to be slotted into a number of categories based on the agent's skill types and levels.

The primary objective of call-distribution algorithms is to ultimately maximize call center performance. That may involve minimizing cost, maximizing call throughput, and/or maximizing revenue, among others. For example, when a new call arrives, the call should be handled by an agent who either has the ability to produce the most revenue or can handle the call in the shortest amount of time. Also, when an agent becomes available to handle a new call, the agent should handle either the call that has the possibility of generating the most revenue or the call that the agent is most efficient in handling.

It is known that in call centers agents are not always fully utilized. That is, agents are not always busy with an active call or carrying out call-work related tasks. The knowledge and skills associated with agents that are not actively handling call related activities are essentially untapped knowledge areas that other agents currently handling call related activities do not have access to. As a result, these resources are not utilized to further a business' goals and/or objectives, and others agents are not able to utilize the full resources of the call center.

One embodiment of the present invention is a method of utilizing agents in an automatic call distribution system that includes providing at least one plug-in that implements at least one predetermined function in the call distribution system. At least one plug-in is assigned to at least one agent. At least one plug-in is activated for a respective assigned agent in response to at least one predetermined parameter of the automatic call distribution system. For example, a predetermine parameter may be the entering into of available/idle time by the respective agent. The plug-in may be one of training, agent-to-agent collaboration, mentoring, and monitoring.

In another embodiment, an apparatus utilizes agents in an automatic call distribution system having a plurality of agents and a plurality of agent functions. A determination module determines respective agent functions for respective agents. An assignment module, operatively connected to the determination module, assigns the respective agent functions to the respective agents and stores the assigned agent functions in storage. An activating module retrieves the respective agent function from the storage and activates the respective agent function for a respective assigned agent in response to at least one predetermined parameter of the automatic call distribution system.

While the present invention is susceptible of embodiments in various forms, there is shown in the drawings and will hereinafter be descried some exemplary and non-limiting embodiments, with the understanding that the present disclosure is to be considered an exemplification of the invention and is not intended to limit the invention to the specific embodiments illustrated.

In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

### BRIEF DESCRIPTION OF THE DRAWINGS

The features of the present invention, which are believed to be novel, are set forth with particularity in the appended claims. The invention may best be understood by reference to the following description taken in conjunction with the accompanying drawings, in the several figures of which like reference numerals identify like elements, and in which:

FIG. 1 is a general block diagram of one embodiment of a communication system.

FIG. 2 is a depiction of the databases stored in memory of an embodiment of the present invention.

FIG. 3 is another block diagram showing more detail of an embodiment of the present invention.

FIG. 4 is a flow diagram depicting one embodiment of a method of utilizing agents.

FIG. 5 is a block diagram depicting different modules in one embodiment of an exemplary call center system for utilizing agents.

FIG. 6 is a computer readable media having computer program code segments for an exemplary example of a call center system for utilizing agents.

### DETAILED DESCRIPTION

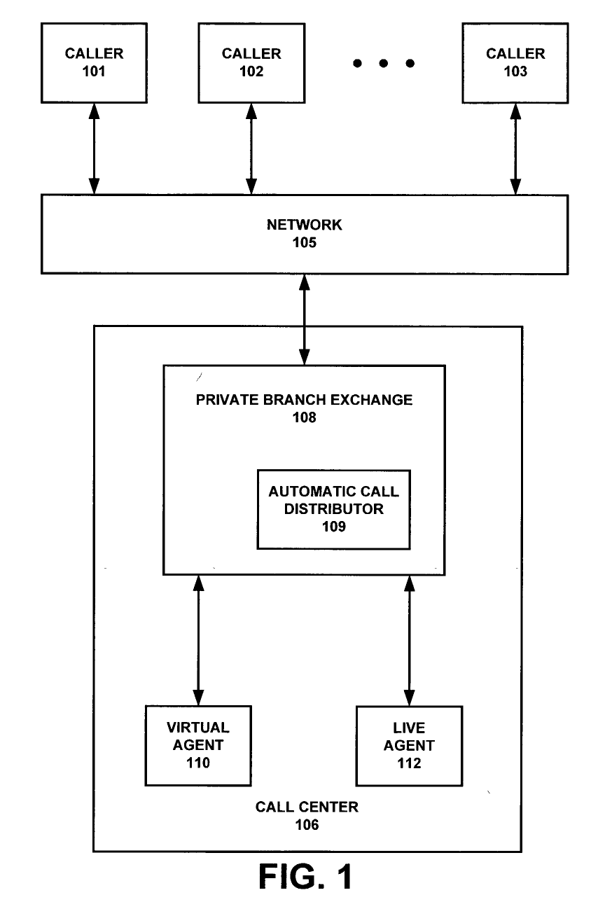

FIG. 1 is a block diagram of a specific embodiment of a telephone system having an automatic call distributor 109 that is part of a private branch exchange 108 in a call center 106. Calls may be connected between callers 101, 102, 103 via a network 105 to an automatic call distributor 109. The automatic call distributor 109 may distribute the calls to telemarketers or agents, such as virtual agent 110, or live agent 112. The network 105 may be any appropriate communication system network such as a public switch telephone network, cellular telephone network, satellite network, land mobile radio network, the Internet, etc. Similarly, the automatic call distributor 109 may be a stand-alone unit, or may be integrated in a host computer, distributed among multiple computers, etc. The illustrated embodiment may be implemented under any of number of different formats. For example, where implemented in connection with a public switch telephone network, a satellite network, a cellular or land mobile radio network, the illustrated embodiment of FIG. 1 may operate within a host computer associated with the automatic call distributor and may receive voice information (such as pulse code modulation data) from a switched circuit connection which carries a voice between the callers 101, 102, 103 and the agents 110, 112.

An alternative embodiment, which may be implemented, for example, in connection with the Internet, may operate from within a server. Voice information may be carried between the agents 110, 112 and callers 101, 102, 103 using packets.

As shown in the embodiment of FIG. 1, a caller, such as caller 101, may place a call to the call center 106. The caller 101 typically uses a station set that may be, for example, embodied as a conventional telephone, videophone or personal computer configured with appropriate telephony software and Internet connectivity. The call is routed via the communication network 105 to the call center 106, in a conventional manner. The call in the illustrated embodiment may be routed within the call center 106 to the private branch exchange 108 that has the automatic call distributor 109. The private branch exchange switch 108 and the automatic call distributor 109 may comprise conventional hardware and software, as modified herein to carry out the desired functions and operations.

Generally, the private branch exchange switch 108 and the automatic call distributor 109 of the embodiment of FIG. 1 form a switching system designed to receive calls destined for the call center 106, and queue them when an appropriate agent is not available. In addition, the automatic call distributor 109 distributes calls to agents or specific groups of agents according to a prearranged scheme. The automatic call distributor 109 may be integrated with the private branch exchange 108, as in the illustrative embodiment shown in FIG. 1, or provided by a separate unit.

The telephone network 105, in the illustrated embodiment of FIG. 1 may include the combination of local and long distance wire or wireless facilities and switches known as the public switched telephone network, as well as cellular network systems and the telephony feature of the Internet. The telephone network 105 may be utilized to complete calls, for example, between (i) a caller at a station set, such as callers 101, 102, 103, and the call center 106; (ii) a caller on hold and a third party; and (iii) a caller on hold and a shared-revenue telephone service, such as a 900 or 976 service, provided by content provider. As is well known, shared-revenue telephone services deliver a particular service over the telephone and subsequently bill the caller. The telephone number from which a call is made typically identifies the caller. A subsequent bill is then included as part of the caller's regular telephone bill.

The Internet network, as used herein, includes the World Wide Web (the “Web”) and other systems for storing and retrieving information using the Internet or other computer network. To view a web site, the user communicates an electronic Web address, referred to as a Uniform Resource Locator (“URL”), associated with the web site. It is noted that if the caller accesses the call center 100 from a conventional telephone, the textual portions of a premium web site may be converted to speech for presentation to the caller.

In one embodiment, a system programmatically utilizes a contact handler's (agent) idle time for purposes of training, agent-to-agent collaboration, mentoring, monitoring, etc. by a series of steps. In the first step, an appropriate idle time plug-in (training, collaboration, etc.) is determined. In the next step, the plug-in base of a series of configuration parameters set by the center for the specific agent is activated. Thereafter, the agent is returned to active duty after a predetermined time period or when a contact arrives that requires the agent's skills. In the context of an automatic call distribution center, the contact handler would be an agent and a contact refers to a call transaction wherein the agent communicates with a caller in, for example, in a telemarketing setting.

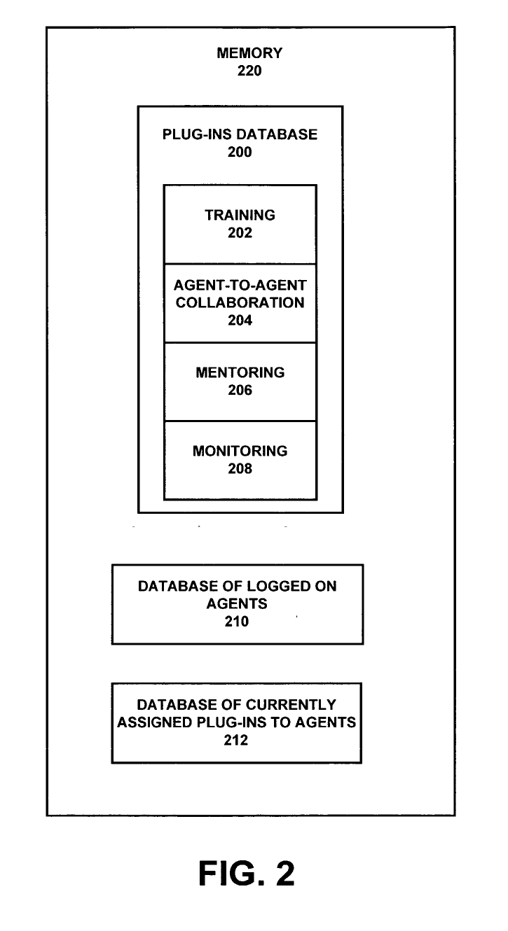

The system, for example the automatic call distributor 109 (depicted in FIG. 1), typically may have a memory 220 as depicted in FIG. 2. The memory 220 may have a plug-in database 200, which comprises training 202, agent-to-agent collaboration 204, mentoring 206, and monitoring 208 in this illustrated embodiment. Other plug-ins may be used with embodiments of the present invention. The memory 220 also has a database of agents that are logged onto the system referred to as database of logged-on agent 210. Furthermore, there is a database 212 of currently assigned plug-ins to agents.

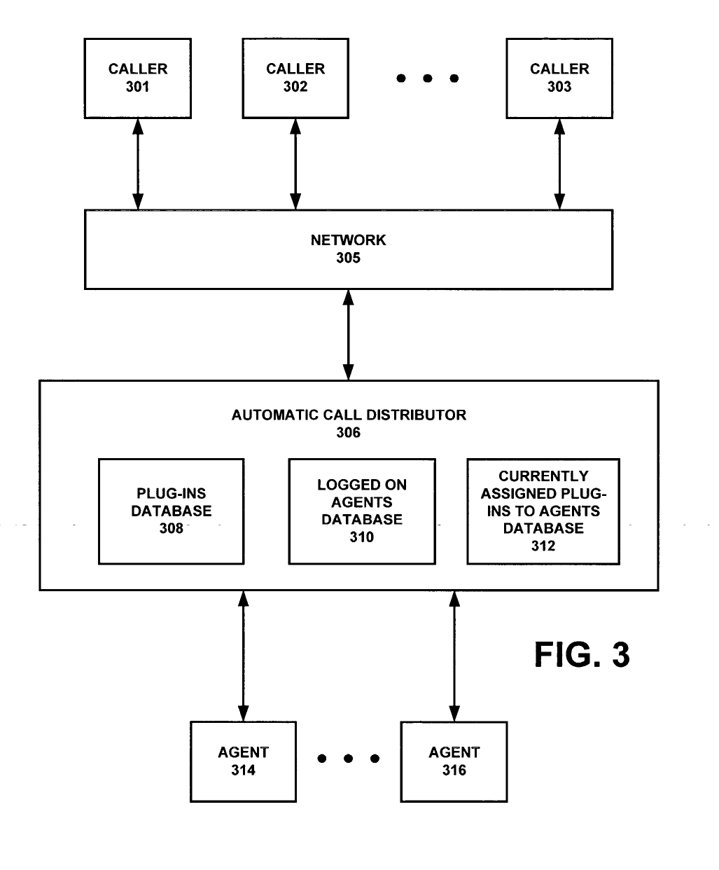

In another embodiment depicted in FIG. 3, an automatic call distributor 306 connects one of the callers 301, 302, 303 via the network 305 to one of the agents 314, 316. The automatic call distributor 306 keeps track of the logged-on agents by the logged-on agents database 310. Initially, or periodically, or on an ongoing basis, agents may be assigned to the various plug-ins. This information may be stored in a currently assigned plug-in to agent database 312. In one embodiment, when one of the agents 314, 316 becomes available, that is, when the agent is not connected with a caller; the automatic call distributor 306 then accesses the plug-in database 308 and enables one of the pre-configured appropriate plugs-ins for this agent. For example, this agent may be used to assist other agents in specific problem areas.

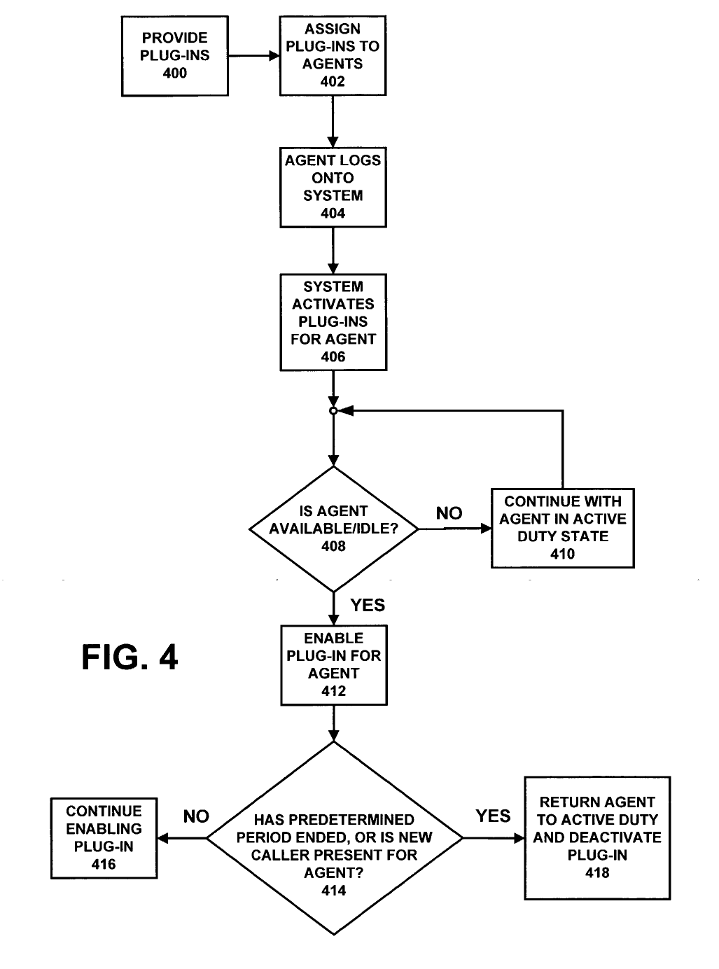

FIG. 4 is a flow diagram depicting one embodiment of a method of utilizing agents in which plug-ins are initially provided that implement at least one predetermined function in the call distribution system, or other communication systems as illustrated at step 400. Thereafter, the plug-ins are assigned to various agents in step 402. In step 404, the system keeps track of which agents are logged on to the system. The system activates plug-ins for an agent in step 406. Then in step 408, it is determined whether an agent is available/idle. If the agent is not available/idle, then according to step 410, the agent continues in the active duty state and the method returns again to check on this agent at periodic intervals or other predetermined criteria. If the agent is available/idle, then the plug-in for this agent is enabled in step 412. In step 414, it is determined whether a predetermined period has ended or if a new caller is present for this particular agent. If this is not the case, then the plug-in continues to be enabled in step 416. However, if a predetermined period is used and has ended or if a new caller is present which is to be assigned to this agent, then the agent is returned to active duty and the plug-in is deactivated according to step 418.

In some embodiments, the automatic call distribution system has a plurality of agents and a plurality of plug-ins. Agents are then matched and assigned to at least one plug-in. Of course, it is to be understood that not all agents need to be assigned to plug-ins in the system, and that agents may be assigned to more than one plug-in. In a further embodiment, the plug-ins are activated for a respective agent when the respective agent logs on to the system. The predetermined parameter may be the entering into of an available/idle time by a respective agent. Plug-ins may be at least one of training, agent-to-agent collaboration, mentoring, monitoring, etc.

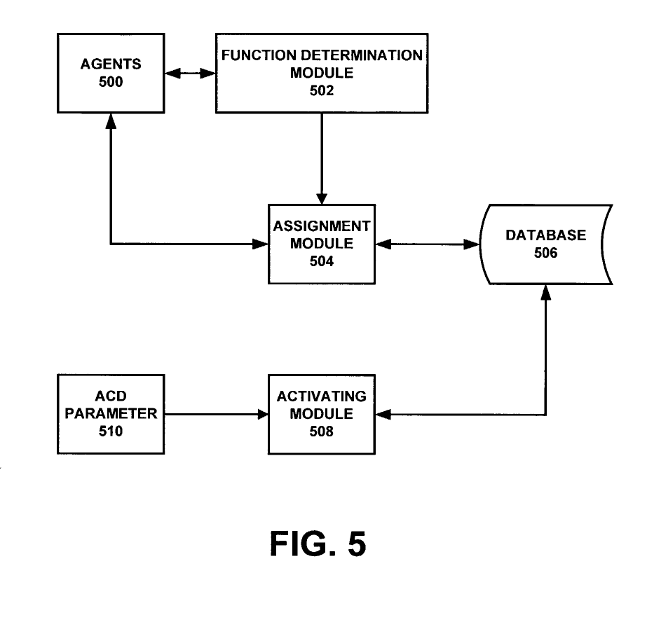

FIG. 5 depicts the element of one embodiment of an apparatus for utilizing agents in a call center. A function determination module 502 determines for a plurality of agents 500 respective agent functions for respective agents. An assignment module 504 is operatively connected to the determination module 502. This assignment module 504 assigns a respective agent function to a respective agent. The assignment module 504 also stores the assigned agent functions in a storage or database 506. An activating module 508 is operatively connected to the storage or database 506 and retrieves a respective agent function from the storage, and activates the respective agent function for a respective assigned agent in response to at least one predetermined parameter that occurs in the automatic call distribution system.

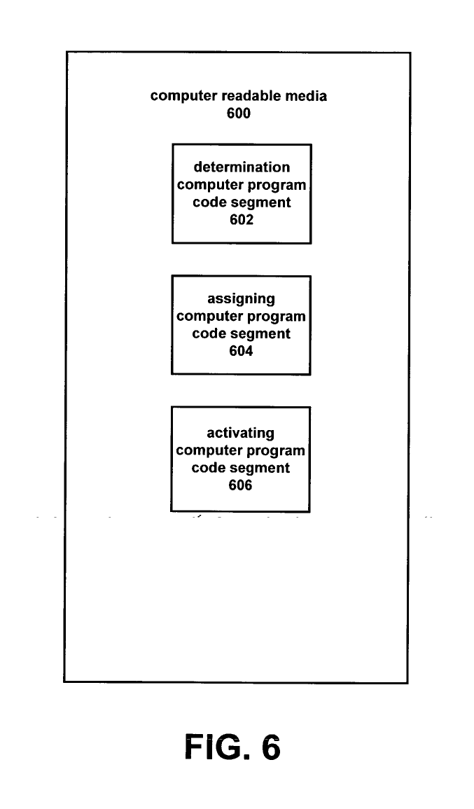

FIG. 6 depicts a computer readable media 600 that contains computer program code segments corresponding to the functions illustrated in FIG. 5. A determination computer program code segment 602 determines respective agent functions for respective agents, and assigning computer program code segment 604 assigns the respective agent functions to the respective agents. Finally, an activating computer program code segment 606 activates at least one agent function for respective assigned agent in response to at least one predetermined parameter of the automatic call distribution system. The computer readable media may be any suitable storage medium including not nor limited to semiconductor ram, rom or flash memory, CD's, DVD's, paper tape, punch cards, and any optical, magnetic, and semiconductor recording mediums or the like.

It is to be understood, of course, that the present invention in various embodiments can be implemented in hardware, software, or in combinations of hardware and software.

The present invention is not limited to the particular details of the apparatus and method depicted, and other modifications and applications are contemplated. Certain other changes may be made in the above-described apparatus and method without departing from the true spirit and scope of the invention herein involved. For example, the present invention may be utilized in other types of communication systems or other environments, other than an automatic call distribution system. For example, the present invention can be utilized in an Internet based environment wherein communication between agents and agents and callers takes place utilizing video and text as well as audio. It is intended, therefore, that the subject matter in the above depiction shall be interpreted as illustrative and not illuminating sense.

What is claimed is:

1. A method of utilizing agents in a communication system, comprising the steps of:
providing at least one plug-in that implements at least one predetermined function in the communication system;
assigning the at least one plug-in to at least one agent; and
activating the at least one plug-in for a respective assigned agent of the at least one agent in response to at least one predetermined parameter of the communication system.

2. The method according to claim 1, wherein the communication system has a plurality of agents and a plurality of plug-ins, and wherein the method further comprises determining for a respective agent of the plurality of agents at least one plug-in, which is assigned to the respective agent.

3. The method according to claim 1, wherein the method further comprises determining at least one predetermined parameter for the respective agent, and wherein the at least one plug-in for the respective agent is activated in response to the at least one predetermined parameter for the respective agent.

4. The method according to claim 3, wherein the method further comprises the step of activating the at least one plug-in for the respective agent when the respective agent logs onto the communication system.

5. The method according to claim 3, wherein the predetermined parameter is an entering into of an available/idle time by the respective agent.

6. The method according to claim 3, wherein the respective agent is in active duty when the respective agent is connected with an inbound caller by the communication system and is in available/idle time when the respective agent is not connected with an inbound caller by the communication system, wherein the plug-in is an idle time plug-in that is activated when the respective agent in not connected with an inbound caller, and wherein the respective agent is returned to active duty upon the occurrence of at least one of an end of a predetermined time period and connection to an inbound caller by the communication system.

7. The method according to claim 1, wherein the at least one plug-in is at least one of training, agent-to-agent collaboration, mentoring, and monitoring.

8. A method of utilizing agents in an automatic call distribution system, comprising the steps of:
providing a plurality of agents and a plurality of plug-ins;
determining respective plug-ins for respective agents;
assigning the respective plug-ins to the respective agents; and
activating at least one plug-in for a respective assigned agent in response to at least one predetermined parameter of the automatic call distribution system.

9. The method according to claim 8, wherein the method further comprises the step of activating respective plug-ins for a respective agent when the respective agent logs onto the automatic call distribution system.

10. The method according to claim 8, wherein the predetermined parameter is an entering into of an available/idle time by the respective agent.

11. The method according to claim 8, wherein a respective plug-in of the plurality of plug-ins is at least one of training, agent-to-agent collaboration, mentoring, and monitoring.

12. The method according to claim 8, wherein a respective agent is in active duty when the respective agent is connected with an inbound caller by the automatic call distribution system and is in available/idle time when the respective agent is not connected with an inbound caller by the automatic call distribution system, wherein the plug-in is an idle time plug-in that is activated when the respective agent in not connected with an inbound caller, and wherein the respective agent is returned to active duty upon occurrence of at least one of an end of a predetermined time period and connection to an inbound caller by the automatic call distribution system.

13. A method of utilizing agents in an automatic call distribution system, comprising the steps of:
providing a plurality of agents and a plurality of agent functions;
determining respective agent functions for respective agents;
assigning the respective agent functions to the respective agents; and
activating at least one agent function for a respective assigned agent in response to at least one predetermined parameter of the automatic call distribution system.

14. The method according to claim 13, wherein the method further comprises the step of activating respective functions for a respective agent when the respective agent logs onto the automatic call distribution system.

15. The method according to claim 13, wherein the predetermined parameter is an entering into of an available/idle time by the respective agent.

16. The method according to claim 13, wherein a respective agent function of the plurality of functions is at least one of training, agent-to-agent collaboration, mentoring, and monitoring.

17. The method according to claim 13, wherein a respective agent is in active duty when the respective agent is connected with an inbound caller by the automatic call distribution system and is in available/idle time when the respective agent is not connected with an inbound caller by the automatic call distribution system, wherein the function is an idle time function that is activated when the respective agent in not connected with an inbound caller, and wherein the respective agent is returned to active duty upon occurrence of at least one of an end of a predetermined time period and connection to an inbound caller by the automatic call distribution system.

18. A computer readable medium containing embedded computer program code for use in utilizing agents in an automatic call distribution system having a plurality of agents and a plurality of agent functions, the computer readable media containing computer program code segments comprising:
a determination computer program code segment that determines respective agent functions for respective agents;
an assigning computer program code segment that assigns the respective agent functions to the respective agents; and
an activating computer program code segment that activates at least one agent function for a respective assigned agent in response to at least one predetermined parameter of the automatic call distribution system.

19. The computer program product according to claim 18, wherein the computer readable media further comprises an activation computer program code segment that activates respective functions for a respective agent when the respective agent logs onto the automatic call distribution system.

20. The computer program product according to claim 18, wherein the predetermined parameter is the entering into an available/idle time by the respective agent.

21. The computer program product according to claim 18, wherein a respective agent function of the plurality of functions is at least one of training, agent-to-agent collaboration, mentoring, and monitoring.

22. The computer program product according to claim 18, wherein a respective agent is in active duty when the respective agent is connected with an inbound caller by the automatic call distribution system and is in available/idle time when the respective agent is not connected with an inbound caller by the automatic call distribution system, wherein the function is an idle time function is activated when the respective agent in not connected with an inbound caller, and wherein the respective agent is returned to active duty upon occurrence of at least one of an end of a predetermined time period and connection to an inbound caller by the automatic call distribution system.

23. An apparatus that utilizes agents in a communication system, comprising:
means for providing at least one plug-in that implements at least one predetermined function in the call distribution system;
means for assigning the at least one plug-in to at least one agent; and
means for activating the at least one plug-in for a respective assigned agent of the at least one agent in response to at least one predetermined parameter of the communication system.

24. The apparatus according to claim 23, wherein the communication system has a plurality of agents and a plurality of plug-ins, and wherein the apparatus further comprises means for determining for a respective agent of the plurality of agents at least one plug-in, which is assigned to the respective agent.

25. The apparatus according to claim 23, wherein the apparatus further comprises determining at least one predetermined parameter for the respective agent, and wherein the at least one plug-in for the respective agent is activated in response to the at least one predetermined parameter for the respective agent.

26. The apparatus according to claim 25, wherein the apparatus further comprises the step of activating the at least one plug-in for the respective agent when the respective agent logs onto the communication system.

27. The apparatus according to claim 25, wherein the predetermined parameter is the entering into an available/idle time by the respective agent.

28. The apparatus method according to claim 25, wherein the respective agent is in active duty when the respective agent is connected with an inbound caller by the communication system and is in available/idle time when the respective agent is not connected with an inbound caller by the communication system, wherein the plug-in is an idle time plug-in that is activated when the respective agent in not connected with an inbound caller, and wherein the respective agent is returned to active duty upon occurrence of at least one of an end of a predetermined time period and connection to an inbound caller by the communication system.

29. The apparatus according to claim 23, wherein the apparatus has a plurality of plug-ins, and wherein the plurality of plug-ins has respective plug-ins that implement respective functions of training, agent-to-agent collaboration, mentoring, and monitoring.

30. An apparatus that utilizes agents in an automatic call distribution system having a plurality of agents and a plurality of agent functions, comprising:
means for determining respective agent functions for respective agents;
means for assigning the respective agent functions to the respective agents; and
means for activating at least one agent function for a respective assigned agent in response to at least one predetermined parameter of the automatic call distribution system.

31. The apparatus according to claim 30, wherein the apparatus further comprises the means for activating respective functions for a respective agent when the respective agent logs onto the automatic call distribution system.

32. The apparatus according to claim 30, wherein the predetermined parameter is an entering into an available/idle time by the respective agent.

33. The apparatus according to claim 30, wherein a respective agent function of the plurality of functions is at least one of training, agent-to-agent collaboration, mentoring, and monitoring.

34. The apparatus according to claim 30, wherein a respective agent is in active duty when the respective agent is connected with an inbound caller by the automatic call distribution system and is in available/idle time when the respective agent is not connected with an inbound caller by the automatic call distribution system, wherein the function is an idle time function that is activated when the respective agent in not connected with an inbound caller, and wherein the respective agent is returned to active duty upon occurrence of at least one of an end of a predetermined time period and connection to an inbound caller by the automatic call distribution system.

35. An apparatus that utilizes agents in an automatic call distribution system having a plurality of agents and a plurality of agent functions, comprising:
a determination module that determines respective agent functions for respective agents;
an assignment module operatively connected to the determination module, the assignment module assigning the respective agent functions to the respective agents and storing the assigned agent functions in a storage; and
an activating module operatively connected to the storage, the activating module retrieving the respective agent function from the storage and activating the respective agent function for a respective assigned agent in response to at least one predetermined parameter of the automatic call distribution system.

36. The apparatus according to claim 35, wherein the apparatus further comprises the activation module activating respective functions for a respective agent when the respective agent logs onto the automatic call distribution system.

37. The apparatus according to claim 35, wherein the predetermined parameter is an entering into an available/idle time by the respective agent.

38. The apparatus according to claim 35, wherein a respective agent function of the plurality of functions is at least one of training, agent-to-agent collaboration, mentoring, and monitoring.

39. The apparatus according to claim 35, wherein a respective agent is in active duty when the respective agent is connected with an inbound caller by the automatic call distribution system and is in available/idle time when the respective agent is not connected with an inbound caller by the automatic call distribution system, wherein the function is an idle time function that is activated when the respective agent in not connected with an inbound caller, and wherein the respective agent is returned to active duty upon occurrence of at least one of an end of a predetermined time period and connection to an inbound caller by the automatic call distribution system.
